(19) United States
(12) Patent Application Publication
(10) Pub. No.: US 2025/0249577 A1
(43) Pub. Date: Aug. 7, 2025

(54) A LEARNING ASSISTED ROBOTIC SYSTEM, A LEARNING ASSISTED METHOD AND A GRIPPER SUBASSEMBLY

(71) Applicant: Logistics and Supply Chain MultiTech R&D Centre Limited, Pok Fu Lam (HK)

(72) Inventors: Ka Lun FAN, Pok Fu Lam (HK); Chung Hang LEUNG, Pok Fu Lam (HK); Wang Fei NG, Pok Fu Lam (HK); Shu Hang IP, Pok Fu Lam (HK)

(21) Appl. No.: 18/435,039

(22) Filed: Feb. 7, 2024

(51) Int. Cl. B25J 9/16; B25J 5/00

(52) U.S. Cl. CPC B25J 9/163; B25J 5/007; B25J 9/1697

(57) ABSTRACT

A learning assisted robotic system for transferring one or more target objects, including a robotic module arranged to transfer a target object from a starting position to a destination, at least one of the starting position and the destination being a three-dimensional environment at least partially enclosed and having an entrance through which being accessible by the robotic module; and a learning module arranged to learn the three-dimensional positions of the entrance and the target object based on one or more training data sets; wherein the learning module is further arranged to derive a navigational path based on the learnt three-dimensional positions whereby the robotic module is operable to navigate through the derived navigational path to transfer the target object from the starting position to the destination.

### TECHNICAL FIELD

The invention relates to a learning assisted robotic system, a learning assisted method and a gripper subassembly or, although not exclusively, to a learning assisted robotic system for transferring one or more target objects, a learning assisted method of transferring one or more target objects, and a gripper subassembly for transferring one or more target objects.

### BACKGROUND

Per the World Apparel Fiber Consumption Survey conducted by the Economic and Social Development Department of the Food and Agriculture Organization of the United Nations (EST/FAO) and the International Cotton Advisory Committee (ICAC), there is a great increase in the world apparel fiber consumption. The total fiber consumption has increased up to 70 million tons by 2010. Cotton and polyester are the two main fiber sources. By 2015, about 54% of fiber is polyester while about 28% of the fiber is cotton. However, 12.4 million tons of textile waste was generated in 2013.

With a huge amount of textile waste produced annually, great pressure was imposed on landfill and the fiber supply chain. To alleviate the pressure on landfill and reduce the demand for virgin raw material, it is necessary to recycle the textile waste and reduce the amount of textile waste going to the landfill.

### SUMMARY OF THE INVENTION

In accordance with a first aspect of the present invention, there is provided a learning assisted robotic system for transferring one or more target objects, comprising:
a robotic module arranged to transfer a target object from a starting position to a destination, at least one of the starting position and the destination being a three-dimensional environment at least partially enclosed and having an entrance through which being accessible by the robotic module; and
a learning module arranged to learn the three-dimensional positions of the entrance and the target object based on one or more training data sets;
wherein the learning module is further arranged to derive a navigational path based on the learnt three-dimensional positions whereby the robotic module is operable to navigate through the derived navigational path to transfer the target object from the starting position to the destination.

In accordance with the first aspect, the system further comprises a sensing unit arranged to capture the data associated with the position and orientation of the object proximate to the robotic module and the training data set includes the captured data by the sensing unit.

In accordance with the first aspect, the robotic module is arranged to navigate to an intermediate position from an initial position and the sensing unit is arranged to capture the data associated with the position and orientation of the object proximate to the robotic module whereby the learning module is arranged to derive the further movement of the robotic module forming part of the navigational path based on the captured data by the sensing unit at the initial position and the intermediate position respectively.

In accordance with the first aspect, the learning module is further configured to estimate the depth of the partially enclosed three-dimensional environment beyond the entrance based on the learnt three-dimensional positions and the robotic module is arranged to navigate into the partially enclosed three-dimensional environment based on the estimated depth.

In accordance with the first aspect, the robotic module further includes an end-effector arranged to pick and release the target object respectively.

In accordance with the first aspect, the learning module is further configured to determine the maneuverable space within the partially enclosed three-dimensional environment and to determine a pick area beyond the entrance and proximate to the target object based on the learnt three-dimensional positions and the robotic module is arranged to estimate the pose for placing the end-effector and navigate the end-effector to the determined pick area.

In accordance with the first aspect, the learning module is further configured to estimate the pose of the target object and the robotic module is arranged to position the end-effector proximate to the target object and pick up the target object.

In accordance with the first aspect, the learning module is further configured to determine the maneuverable space between the entrance and a further three-dimensional environment and the robotic module is arranged to navigate the end-effector to release a picked target object to the further three-dimensional environment.

In accordance with the first aspect, the sensing unit further includes a depth camera unit arranged to capture one or more images associated with the three-dimensional environment, the depth camera unit being movable with respect to a base carrying the robotic module.

In accordance with the first aspect, the sensing unit further includes a compliant end-effector arranged to contact a target object and the data associated with the contact force of the data forms at least part of the training data set.

In accordance with the first aspect, the end-effector further includes a gripper module configured to pick and release the target object, the gripper module comprising a plurality of grippers with the orientation being adjustable to accommodate target object with irregular surface.

In accordance with the first aspect, the gripper includes a needle gripper.

In accordance with a second aspect of the present invention, there is provided a learning assisted method of transferring one or more target objects, comprising the steps of:
learning the three-dimensional positions of the entrance of an at least partially enclosed three-dimensional environment and a target object based on one or more training data sets;
deriving a navigation path for a robotic module based on the learnt three-dimensional positions; and
navigating the robotic module through the derived navigational path to transfer the target object from the starting position to the destination.

In accordance with the second aspect, the method further comprises the steps of:
capturing the data associated with the position and orientation of the object proximate to the robotic module;
retrieving at least part of the training data set from the captured data; and
learning the three-dimensional positions of the entrance of the partially enclosed three-dimensional environment and the target object based on one or more training data sets.

In accordance with the second aspect, the method further comprises the steps of:
capturing the data associated with the position and orientation of the object proximate to the robotic module at an initial position of the robotic module;
navigating the robotic module to an intermediate position from the initial position;
capturing the data associated with the position and orientation of the object proximate to the robotic module at the intermediate position of the robotic module; and
deriving a further movement of the robotic module based on the captured data at the initial position and the intermediate position respectively.

In accordance with the second aspect, the method further comprises the steps of:
learning the three-dimensional positions of the entrance of an at least partially enclosed initial three-dimensional environment and a target object positioned within the initial three-dimensional environment based on one or more training data sets;
deriving a first navigation path for a robotic module based on the learnt three-dimensional positions;
navigating the robotic module into the initial three-dimensional environment from an initial position through the derived first navigational path to pick the target object;
learning the three-dimensional position of a destinated three-dimensional environment based on one or more training data sets;
deriving a second navigation path for the robotic module based on the learnt three-dimensional positions; and
navigating the robotic module to the destinated three-dimensional environment through the derived second navigational path to release the picked target object.

In accordance with the second aspect, the method further comprises the steps of:
learning the three-dimensional positions of the entrance of an initial three-dimensional environment and a target object positioned within the first three-dimensional environment based on one or more training data sets;
deriving a first navigation path for a robotic module based on the learnt three-dimensional positions;
navigating the robotic module into the initial three-dimensional environment through the derived first navigational path to pick the target object;
learning the three-dimensional position of the entrance of an at least partially enclosed destinated three-dimensional environment based on one or more training data sets;
deriving a second navigation path for the robotic module based on the learnt three-dimensional position; and
navigating the robotic module into the destinated three-dimensional environment through the derived second navigational path to release the picked target object.

In accordance with a third aspect of the present invention, there is provided a gripper subassembly for transferring one or more target objects, comprising:
a base arranged to couple to an end-effector of a robotic module; and
a plurality of needle grippers arranged to intrude a portion of the surface of a soft target object in a first direction in response to an electronic signal, the needle grippers being each pivotably mounted on the base and pivotable about a pivoting axis perpendicular to the first intruding direction;
wherein the first intruding direction is adjustable by the pivotal movement of the needle gripper so as to accommodate the shape of the soft target object.

In accordance with the third aspect, the pivoting axis of two adjacent needle grippers are arranged to intersect with each other.

In accordance with the third aspect, each needle gripper includes a gear being rotatable about the pivoting axis and is connectable to another gear as bevel gears.

### BRIEF DESCRIPTION OF THE DRAWINGS

Embodiments of the present invention will now be described, by way of example, with reference to the accompanying drawings in which:

FIG. 1 is a schematic diagram showing the operation workflow of the textile recycling process;

FIG. 2 is a schematic diagram showing the learning assisted robotic system in accordance with one example embodiment of the present invention;

FIG. 3 is a perspective view showing the end-effector of robotic arm as shown in FIG. 2 in a release state;

FIG. 4A is a schematic diagram showing a gripper subassembly in accordance with one example embodiment of the present invention;

FIG. 4B shows an isolated view of a needle gripper of the gripper subassembly as shown in FIG. 3A;

FIG. 4C shows an isolated view of a needle gripper of the gripper subassembly as shown in FIG. 3A;

FIG. 5A is a schematic diagram showing the operation workflow of the automated robot gripping of the washing bags from the blending machine to the container of the learning assisted robotic system; and

FIG. 5B is a schematic diagram showing the operation workflow of the automated robot gripping of the washing bags from the container of the learning assisted robotic system to the drying machine.

### DETAILED DESCRIPTION OF THE PREFERRED EMBODIMENTS

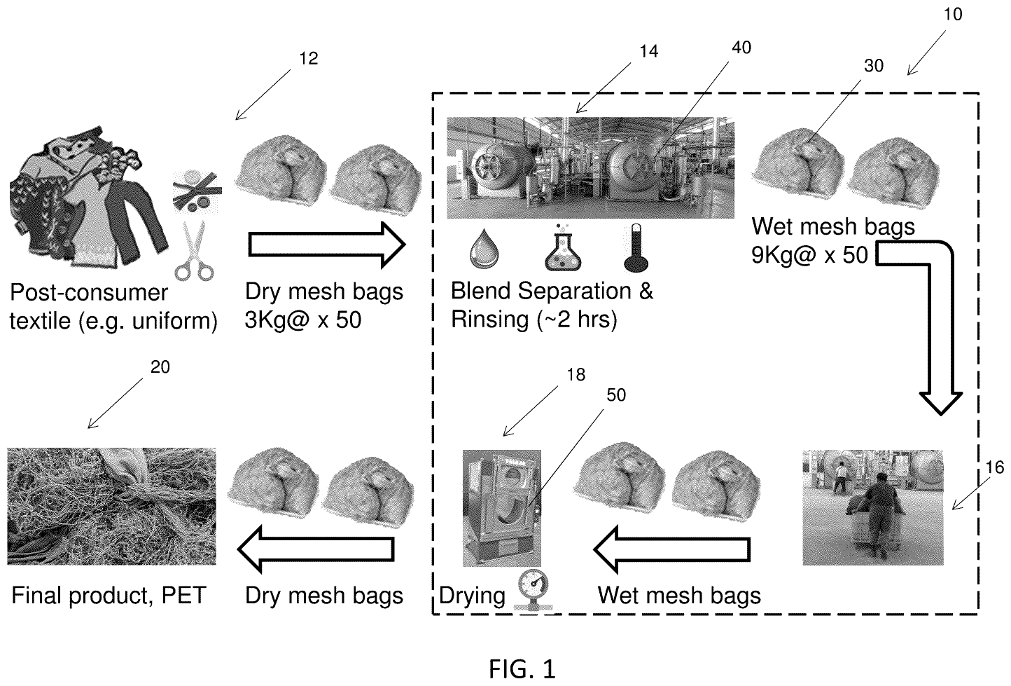

As show in FIG. 1, there is shown a typical textile recycling process 10 which involves a couple of tedious processes, from packing those post-consumer textiles e.g., school uniforms into dry mesh bags 30 (step 12), blend separation and rinsing in a blender 40 (step 14), manually transporting the wet mesh bags 30 from the blender 40 to a dryer (step 16), drying the wet mesh bags 30 in the dryer 50 (step 18), and the final product PET are collected (step 20).

However, there are several pain points in textile recycling process 10. At present, heavy, wet, soft, and chemically-processed mesh bags 30 are manually taken out the blend separation & rinsing machines 40 and transferred to dryers 50 by the operators. As the content in the washing bar are soaked with water, the laundry with water mass gives a very heavy payload and can be approximately 9 kg per bag. Such repetitive loading and unloading tasks are very time consuming and the shortage of skilled labor or aging labor pose a growing concern. Also, the tight and congested area makes the take out and transportation of wet mesh bag 30 very difficult and thus the overall recycling process has a low productivity.

Robots are commonly used in many industrial processes (e.g. manufacturing or fulfilment centers) due to its high productivity and accuracy as well as repeatability provide that the objects (e.g. capacitors, resistors) are used to have fixed dimensions. While automation may improve productivity and resolve labor shortage, conventional robot manipulation may not be able to cope with every object with different physical properties. For instance, the shapes of soft objects are irregular and changed from time to time, and thus objects with irregular shapes and made of soft materials (e.g., textile clothing) pose difficulties for robot manipulations.

Without wishing to be bound by theories, the present inventors, through their own trials and researches, have developed an AI-based robot manipulation technique for soft material handling. For instance, by embedding a Robovator with AI technique, it can be used to automatic take out all wet mesh bags 30 from blender 40 and assist the transportation to dryers 50.

In one example embodiment, the present invention relates to a robovator which includes an active or passive compliant end-effector, a robotic arm maneuverable in tight and changing partially enclosed 3D environment, and a mobile base maneuverable in a compact environment. The present invention also specifically relates to one or more reinforcement learning (RL) modules which may process one or more inputs from various sensing units such as RGB-D camera and sensing capabilities on end-effector and perform one or more subtasks such as determining entrance position, maneuverable space inside enclosed environment, position for picking, and maneuverable space from entrance to collection container.

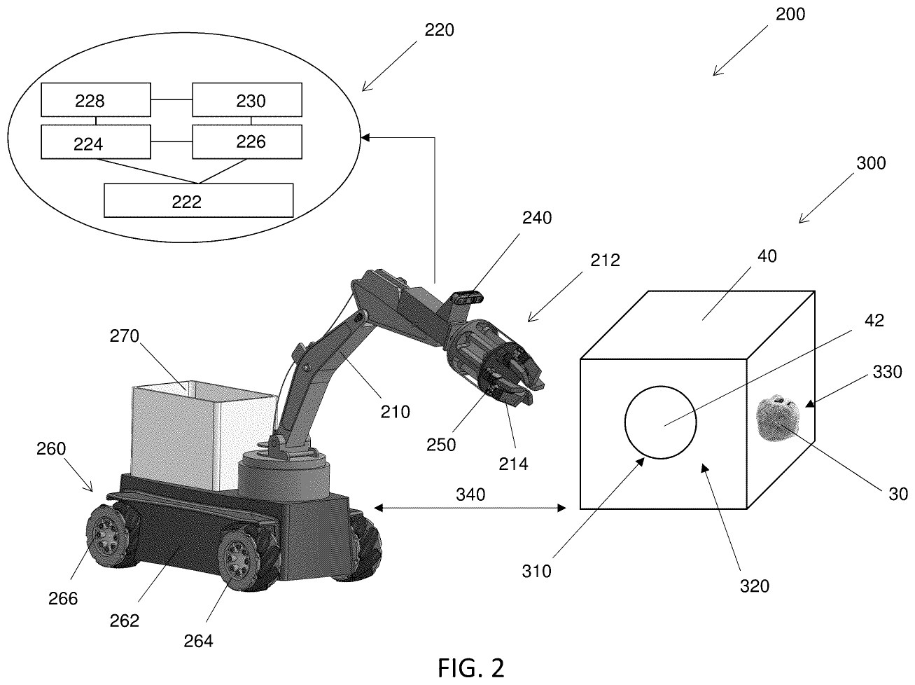

With reference to FIG. 2, there is shown an embodiment of a learning assisted robotic system 200 for transferring one or more target objects 30, comprising: a robotic module 210 arranged to transfer a target object 30 from a starting position to a destination, at least one of the starting position and the destination being a three-dimensional environment 300 at least partially enclosed and having an entrance 42 through which being accessible by the robotic module 210; and a learning module 230 arranged to learn the three-dimensional positions of the entrance 42 and the target object 30 based on one or more training data sets; wherein the learning module 230 is further arranged to derive a navigational path based on the learnt three-dimensional positions whereby the robotic module 210 is operable to navigate through the derived navigational path to transfer the target object 30 from the starting position to the destination.

For the purposes of this document, the term “target object” includes any type of objects, such as, but not limited to, hard and soft objects, object with regular or irregular shape, any kind of objects which may be picked and released by a robotic arm. The term “three-dimensional environment” includes any type of partially enclosed “three-dimensional environment” such as blend machine, drying machine, mesh bag collection container or unconfined space such as the maneuverable space from a starting position to a destination.

As shown in FIG. 2 there is a shown a schematic diagram of a learning assisted robotic system 200. The learning assisted robotic system 200 can be embodied as a robovator 200 in which a computing apparatus 220 is embedded. The robovator 200 comprises two essential parts: a robotic module 210 and a learning module 230 embedded onto the robotic module 210. The robotic module 210 can be embodied in the form of a robotic arm and further includes a robot end-effector 212 which is operable to perform one or more automated actions in response to one or more instructions from the computing apparatus 220. Specially, the end-effector 212 can be attached to the robotic arm 210 and interact with surrounding environments.

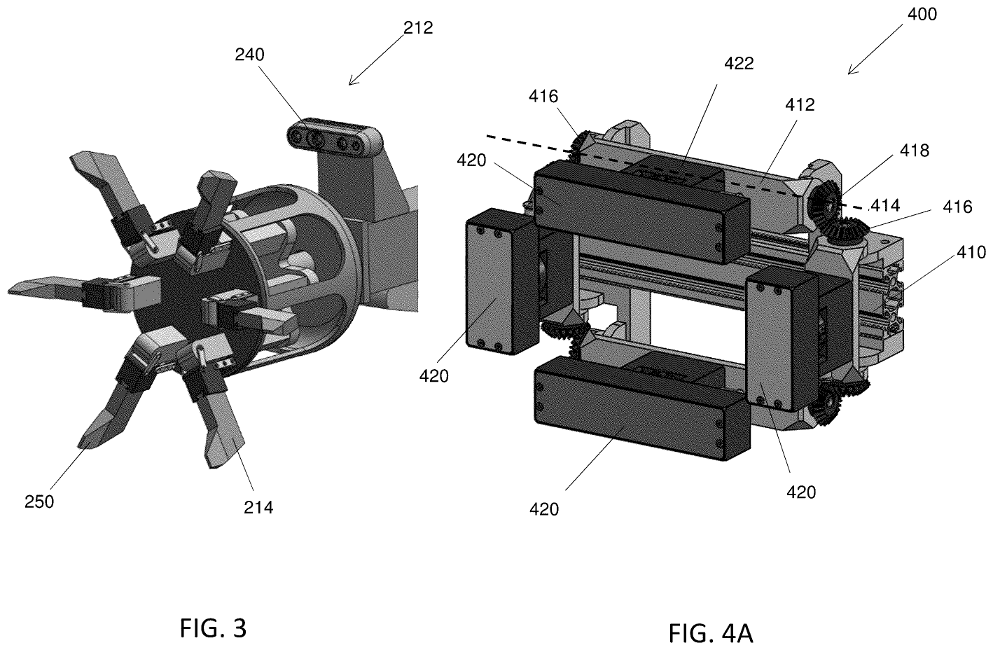

FIG. 3 shows the end-effector 212 of the robotic arm 210 in further details. For instance, the end-effector 212 may be embodied in the form of a mechanical gripper to pick up and manipulate one or more objects. In one example embodiment, the end-effector 212 is in the form of fingers gripper which comes with a plurality of fingers 214. The individual movement of these fingers 214 may be controlled by the computing apparatus 220 so as to grasp and release one or more objects. For instance, the end-effector 212 may be embodied in the form of electric gripper, vacuum grippers, magnetic grippers, pneumatic gripper, needle grippers, or other gripper technologies.

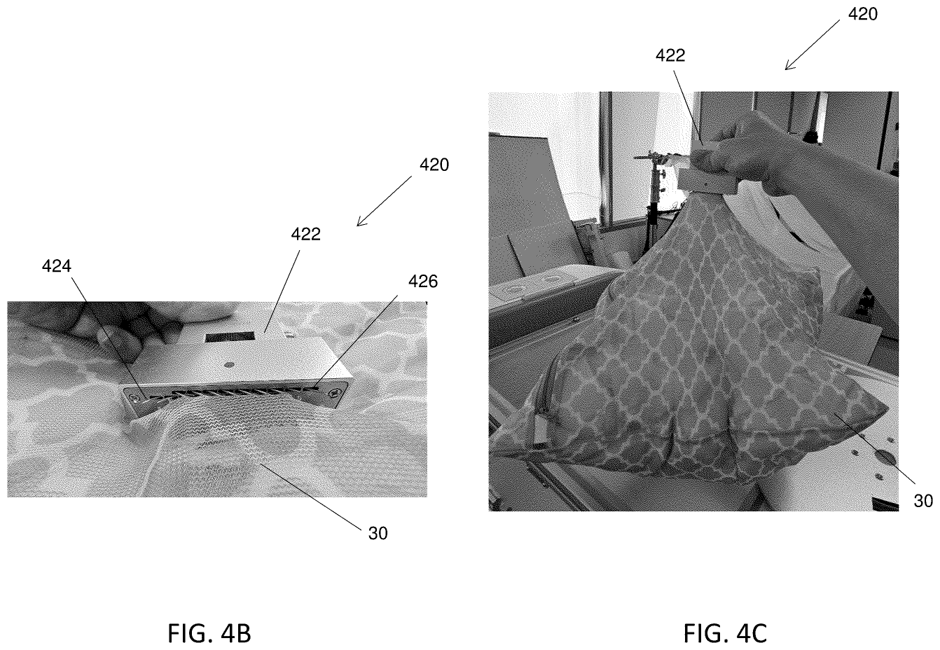

More advantageously, the end-effector 212 may be connected to a further gripper subassembly in accordance with one example of the present invention as shown in FIG. 4A.

Referring to FIG. 2 again, the learning assisted robotic system 200 may comprise a computing apparatus 220 which includes suitable components necessary to receive, store and execute appropriate computer instructions. The components may include a processing unit 222, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM) 224, random access memory (RAM) 226, and input/output devices such as disk drives 228.

In this example embodiment, the processor 222 is configured to receive data from one or more external sensing units. For instance, various forms of data e.g., image data or force data associated with the environment of the blending machine 40 or drying machine 50 or peripheral environment proximate to the blending machine 40 or drying machine 50 may be determined by external sensing units. The processor 222 may be a single processor to provide the combined functions of an image data processor and a force data processor. The computing apparatus 220 may include instructions that may be included in ROM 224, RAM 226, or disk drives 228 and may be executed by the processing unit 222.

Essentially, the computing apparatus 220 further comprise one or more learning module 230 and more specifically a reinforcement learning (RL) module 230. The reinforcement learning (RL) module 230 relies on the sampling of the environment around the robotic system 200 to learn about the environment from one or more training data sets. For instance, the reinforcement learning (RL) module 230 can be configured to receive the state of the robotic arm 210 or the state of the environment around the robotic arm 210 based on one or more sensor data associated with the robotic arm 210. Preferably, the learning module 230 is also embedded within the robovator 200 and movable together with the robovator 200.

The learning assisted robotic system 200 may include one or more sensing units for capturing various environmental data associated with the blending machine 40 or drying machine 50. These sensing units are each arranged in signal communication with the processing unit 222 of the computing apparatus 220 such that the processing unit 222 is configured to receive captured data from the sensing units and process the data in real time to provide refined training data set.

In one example embodiment, there is provided an image capturing module 240 which is operable to capture images of distant objects relative to the robotic system 200.

Preferably, the image capturing module 240 can be a depth camera e.g. RGB-D camera which is positioned externally and at an elevated position relative to the ground without being visually obstructed. For instance, the RGB-D camera 240 can be mounted onto the front arm of the robotic module 210 and at an elevated position relative to the end-effector 212 so as to capture a frontal 3D view from the perspective of the robotic system 200. For instance, the RGB-D camera 240 can capture a plurality of images within a predetermined time period or a video of the objects proximate to the robotic arm 210. In each of the image, various information such as the blending machine door or the drying machine door, and one or more mesh bags 30 in various irregular shapes may be determined by the RGB-D camera 240. Based on a series of captured images, the processor 222 may determine the position and dimensions of the door and the depth of the blending machine 40 or drying machine 50 behind the door, the three-dimensional environments within the blending machine 40 or the drying machine 50, the position and the three-dimensions of the mesh bags 30.

Accordingly, the processor 222 may determine the position of the robotic arm 210 and the maneuverable space of the robotic arm 210 within the three-dimensional environments of the blending machine 40 or the drying machine 50.

In some scenarios or setup, the mesh bags 30 may be very densely packed and appears to be overlapped in the images captured by the image capturing module 240. The environmental data determined based on the captured images alone may not reflect the actual environment in the blending machine 40 or the drying machine 50.

Apart from the image capturing module 240, there is also provided a sensing capability on end-effector 212. For instance, the end-effector 212 may be a robotic force compliant end-effector (RFCEE) 250 which allows the robotic arm 210 to exert force on an object while also sensing the resistance or reaction of the object to the applied force and adjusting the operation accordingly. For instance, the robotic force compliant end-effector (RFCEE) may be actuated by using springs, hydraulic or pneumatic systems.

In one example embodiment, the force compliant end-effector 212 may be an active compliant end-effector which may use sensors and control systems to actively adjust to changes in the environment or in the task being performed. For instance, if the active compliant end-effector 212 abuts an object being manipulated e.g., a washing bag 30 within the blender machine 40 or drying machine 50, the active compliant end-effector may detect the material properties of the washing bag 30 based on the sensed resistance and adjust the gripping force exerted on the washing bag 30 accordingly.

In one alternative example embodiment, the force compliant end-effector 212 may be a passive end-effector which lacks a control system and instead uses various materials or structures such as springs, rubber, or flexible materials as damping means for absorbing the forces and distribute them evenly to achieve compliance. Meanwhile, such resilient property of these materials may reduce the risk of damaging the object being manipulated or the end-effector 212 itself.

As an illustrative example, the reinforcement learning (RL) modules 230 may receive the input from RGB-D camera 240 and sensing capabilities 250 on the End-effector 212.

Based on the data, the reinforcement learning (RL) module 230 may derive a navigational path to a destination and instruct the robotic arm 210 to navigate from an initial position to an intermediate position. As the robotic module 210 navigates from the initial position to an intermediate position, the learning module 230 further collect more info from one or more further inputs associated with the position and orientation of the object proximate to the robotic module 210 and derive the further movement of the robotic module 210.

The robovator 200 further includes a mobile base 260 for carrying the robotic arm 210. The mobile base 260 has a base body 262 with a pair of front wheels 264 and a pair of rear wheels 266 each operably connected to the base body 262, to drive the robovator along a surface manually by an operator. The front wheels 264 and rear wheels are each motorized by a respective servo motor such that the four wheels 264, may be steered in different angles for turning around a corner or an obstacle.

Alternatively, the robovator 200 may be operated as an autonomous vehicle and the steering of the mobile base 260 can be controlled by the computing apparatus 220 instead.

Lastly, the robovator 200 may further include a container 270 e.g. a mesh bag collection container for the temporary storage of items such as washing bags 30. For instance, the mesh bag collection container 270 can be fixedly mounted on the mobile base 260. Optionally, the robovator 200 may include a plurality of containers 270 for the storage of various textile items sorted by the robotic system 200.

Referring to FIG. 2 for the detailed description of the RL-based Mobile Manipulation Control Framework adopted by the learning assisted robotic system 200 in accordance with one example embodiment of the present invention.

In particular, the reinforcement learning (RL) modules 230 may automate at least part of the textile recycling process 10 as described in FIG. 1. In this manner, the reinforcement learning modules 230 may divide the automated transfer of wet mesh bags 30 from the blender machine 40 to the dryer machine 50 into multiple phrases and define a plurality of sub-task environments. The learning assisted robotic system may perform a plurality of automated sub-tasks in each sub-task environment.

In one example embodiment, the automated task of picking mesh bags 30 from the blend separation and rinsing machine 40 to a container 270 may be divided into several sub-task environments for reinforcement learning (RL) to devise the necessary robotic manipulations to accomplish the overall goal. In a sequential order, the three-dimensional environment 300 can be segregated into an entrance environment 310, an inner space environment 320, a picking area environment 330 and a space to container environment 340.

The initial entrance environment 310 refers to the first phrase where the reinforcement learning (RL) modules 230 collect different parameters e.g., the position and dimension of the entrance 42 from the sensor modules 240, 250 and learn the entrance environment prior to moving the robotic arm 210 into the entrance 42 of the blending machine 40. During the initial entrance environment 310, the learning module 230 may determine the entrance position of the blending machine 40. The learning module 230 may obtain the position reference to an entrance 42 of the blending machine 40, estimate the depth beyond entrance 42, and moves the robotic arm 210 into enclosed space defined by the blending machine 40.

The inner space environment 320 refers to the second phrase where the reinforcement learning (RL) modules 230 collect different parameters e.g. the location of the mesh bags 30 within the blending machine 40 and learn the pick area environment prior to moving the robotic arm 210 closer to the pick area. During the inner space environment 320, the learning module 230 may determine the maneuverable space inside the enclosed environment of the blending machine 40.

The learning module 230 may obtain the maneuverable space inside the blending machine 4, determine a pick area, estimate the pose for placing the end-effector 212, and move the end-effector 212 close to pick area.

During the picking area environment 330, the learning module 230 may determine the position for picking. The learning module 230 may estimate the pose of target mash bag 30, position the end-effector 212 to the target mesh bag 30, and pick up the target mesh bag 30.

Finally, during the space to container environment 340, the learning module 230 may determine the maneuverable space from entrance 42 to collection container 270. The learning module 230 may obtain the maneuverable space from entrance 42 to collection container 270, move the end-effector 212 right above container 270, and release the bag 30 to container 270.

Similarly, in one alternative example embodiment, the automated task of picking mesh bags 30 from the container 270 to a dryer 50 may also be divided into several sub-task environments for reinforcement learning (RL) to devise the necessary robotic manipulations to accomplish the overall goal. For instance, in a sequential order, the environment can be segregated into a container to space environment, an entrance environment, an inner space environment and a placing area environment.

While the end-effector 212 of the robotic arm 210 as shown in FIGS. 2 and 3 are more suitable for gripping objects with regular shapes, the learning module 230 may predict the pose of an irregular soft mash bag 30 and orient the end-effector 212 at a better pose before approaching the mash bag 30 so as to improve the success rate of the gripping. In addition, the end-effector 212 may be equipped with a gripper subassembly which may handle heavy duty loadings.

With reference to FIG. 4A, there is shown an embodiment of a gripper subassembly for transferring one or more target objects 30, comprising: a base 410 arranged to couple to an end-effector 212 of a robotic module 210; and a plurality of needle grippers 420 arranged to intrude a portion of the surface of a soft target object 30 in a first direction in response to an electronic signal, the needle grippers 420 being each pivotably mounted on the base 410 and pivotable about a pivoting axis 414 perpendicular to the first intruding direction; wherein the first intruding direction is adjustable by the pivotal movement of the needle gripper 420 so as to accommodate the shape of the soft target object 30.

In one example embodiment, the gripper subassembly 400 includes a mounting base which can be detachably mounted to a robotic module 210 or an end-effector 212 of the robotic module 210. The mounting base 410 further includes a plurality of smaller mounting plates 412 each receiving a needle gripper 420 mounted thereon.

The needle grippers 420 includes a needle base 422 and one or more intruding members that can be extended from the needle base 422 to hold a soft article 30 e.g. a mesh bag and retracted so as to release the article 30.

For instance, the needle grippers 420 as shown in FIG. 4B may include a needle base 422, a first needle group 424 and a second needle group 426 being extended away from the needle base 422 substantially in an intruding direction. While the actuation of such needle gripper 420 may be actuated through spring force or pneumatically, the motion may also be actuated by electronic controls. As an example, each of the needle gripper 420 may handle 3 kg material.

Each of the first needle group 424 and the second needle group 426 includes a plurality of needles, with the needles of the first needle group being extended at a first angle relative to the intruding direction and the needles of the second needle group being extended at a second angle relative to the intruding direction respectively. The first angle can be a positive acute angle relative to the intruding direction, while the second angle can be a negative acute angle relative to the intruding direction. When both of the first needle group 424 and the second needle group 426 are extended, the needles intersect at multiple spots and together forming crossing needles.

By changing the orientation of the need gripper 420, the intruding direction of each needle gripper 420 can be adjusted so as to accommodate targeted gripping object 30 with irregular surface. Preferably, each of the needle grippers 420 can be pivotably mounted onto the mounting base 412 and the intruding direction can be adjusted individually. For instance, the needle base 422 can be mounted onto a respective mounting plate 412 and the mounting plate 412 can be pivotable about a pivoting axis that is perpendicular to the intruding direction.

The gripper subassembly 400 may further include a motor unit (not shown) to control the pivotal movement of the mounting plate 412. Accordingly, the intruding direction of a needle gripper 420 can be adjusted in response to the pivotal movement of the corresponding mounting plate 412. As the multiple needle grippers 420 are positioned on the respective mounting plate 414 and proximate to each other, the pivoting axis of the adjacent needle grippers 420 may intersect with each other. Thus, by adjusting the pivotal position of each mounting plate 412, the intruding direction of each needle gripper 420 can be adjusted to accommodate various object with irregular shapes.

In one further example embodiment, each of the mounting plate 412 may be in mechanical linkage with each other. For instance, each mounting plate 412 may further include a pair of gears 416, 418 each having a tooth bearing face and being rotatable in the same pivoting axis 414. Preferably, the gears 416, 418 are disposed on the outer surface of the mounting plate 412 and in the opposite sides of the mounting plate 412 along the pivoting axis 414. As the needle grippers 420 are positioned perpendicular to each other, the axis of the two adjacent gears 416, 418 would intersect and the tooth bearing face of the gears 416, 418 would contact so as to transfer the mechanical energy from one mounting plate 412 to the other mounting plate 412 perpendicularly. As an example, the bevel gears can be straight bevel gear, spiral bevel gear etc. Accordingly, the loading of the mesh bag 30 may be uniformly shared by each of the needle gripper 420 being mounted onto the gripper subassembly 400.

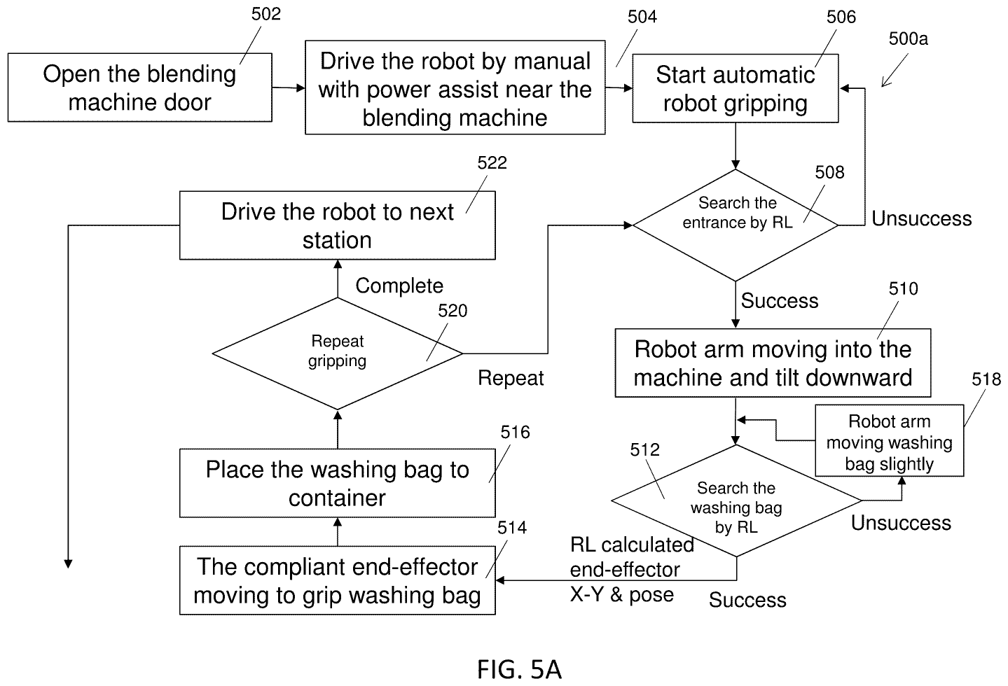

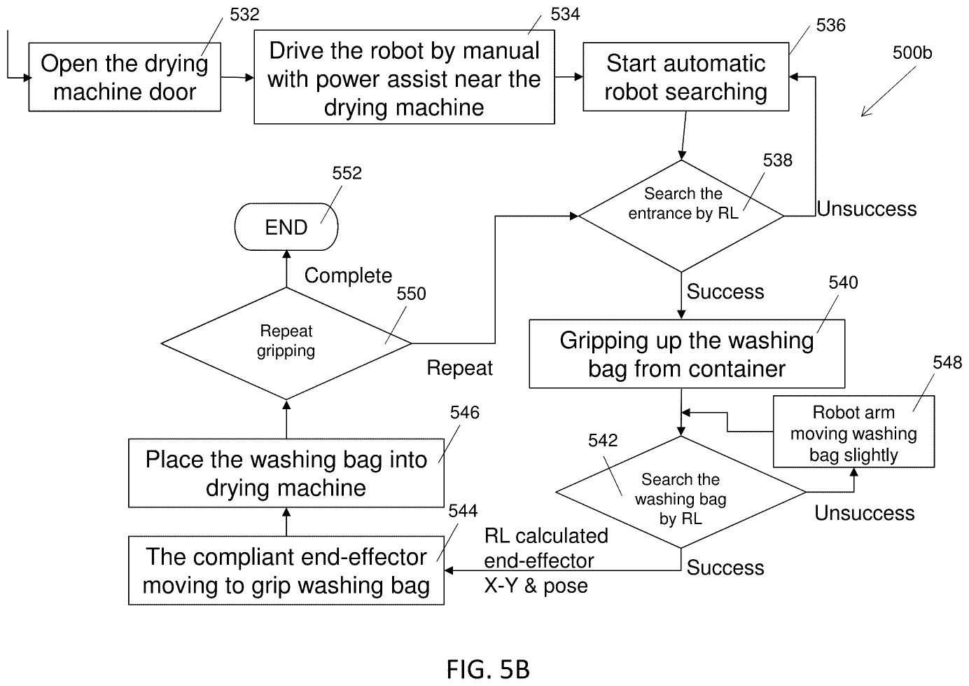

The learning assisted robotic system 200 in accordance with one example embodiment of the present invention can be operated to automatically take out all wet mesh bags from one or more blend separation and rinsing machines 40 and assist the transportation to one or more dryers 50. Thus, the robotic system 200 may automate at least part of the textile recycling process 10 as shown in FIG. 1. For instance, in one operation procedure, the robotic system 200 may be navigated to the blending machine 40 to automatically grip the wet mesh bags 30 and release them to the mesh bag collection container 270 (FIG. 5A). Subsequently, the robotic system 200 may be navigated to the dryer 50 to automatically grip the wet mesh bags 30 from the mesh bag collection container 270 and release them to the dryer 50 for drying (FIG. 5B).

With reference to FIGS. 5A and 5B, there is shown an embodiment of a learning assisted method 500 of transferring one or more target objects 30, comprising the steps of: learning the three-dimensional positions of the entrance 42 of an at least partially enclosed three-dimensional environment 300 and a target object 30 based on one or more training data sets; deriving a navigation path for a robotic module 210 based on the learnt three-dimensional positions; and navigating the robotic module through the derived navigational path to transfer the target object 30 from the starting position to the destination.

The operation mode of one example embodiment of learning assisted robotic system will now be described with reference to FIGS. 5A and 5B in further details. More specifically, the method 500a of transferring a wet mesh bag 30 from the blending machine door to the mesh bag collection container 270 is further described with reference to FIG. 5A, while the method 500b of transferring a wet mesh bag 30 from the mesh bag collection container 270 to the dryer 50 is further described with reference to FIG. 5B.

Referring to FIG. 5A, the method 500a begins with step 502. The operator may first open the blending machine door so that the entrance 42 of the blending machine 40 would be accessible by the robotic arm 210 (step 502). The operator may manually drive the robovator 200 proximate to the blending machine 40 (step 504). Once the robovator 200 is sufficiently proximate to the blending machine 40, the automatic robot gripping may kick start (step 506) and the searching of the entrance 42 by reinforcement learning within the entrance environment 310 begins. For instance, the RGB-D camera 240 may capture a plurality of images and the reinforcement learning (RL) modules 230 may search the entrance 42 from the captured images to learn the position of the entrance 42 of the blending machine 40 (step 508). If the searching is successful and the position of the entrance 42 is known, the robotic arm 210 will move into the blending machine 40 and tilt downward (step 510). However, if the searching is unsuccessful, the robovator 200 will repeat step 508 until the position of the entrance 42 can be identified.

Once the robotic arm 210 is moved into the blending machine 40, the searching of the washing bag 30 by reinforcement learning within the inner space environment 320 and the picking area environment 330 begin simultaneously. The RGB-D camera 240 may capture a plurality of images and the reinforcement learning (RL) modules 230 may search the washing bags 30 from the captured images to learn the position of the washing bags 30 (step 512). If the searching is successful and the orientation of a target washing bag 30 is known, the reinforcement learning (RL) modules 230 will calculate the three-dimensional position and pose of the end-effector 212 and the compliant end-effector 212 will move to grip the targeted washing bag 30 (step 514). However, if the searching is unsuccessful, the robotic arm 210 will move the washing bag 30 in the blending machine 40 slightly and the robovator 200 will repeat step 512 until a washing bag 30 can be found.

As the washing bag 30 is gripped by the compliant end-effector 212, the learning of the space to container environment 340 by reinforcement learning (RL) modules 230 begin. The robotic arm 210 may navigate through a navigation path and place the washing bag 30 to the container 270 (step 516). The pick and place of the rest of the washing bags 30 from the blending machine 40 to the mesh bag collection container will be done by repeating steps 508 to 516 (step 520). Once the last washing bag has been picked from the blending machine 40 and placed into the container 270, method 500a is complete and the operator may drive the robovator 200 to the next station (step 522).

Referring finally to FIG. 5B, the method 500b begins with step 532, and optionally subsequent to step 522. The operator may first open the drying machine door so that the entrance of the drying machine 50 would be accessible by the robotic arm 210 (step 532). The operator may manually drive the robovator 200 proximate to the drying machine 50 (step 534). Once the robovator 200 is sufficiently proximate to the drying machine 50, the automatic robot searching may kick start (step 536) and the searching of the entrance by reinforcement learning within the container to space environment begins. The RGB-D camera 240 may capture a plurality of images and the reinforcement learning (RL) modules 230 may search the entrance from the captured images to learn the position of the entrance of the drying machine 50 (step 538). If the searching is successful and the position of the entrance is known, the robotic arm 210 will move into the mesh bag collection container 270 and ready for gripping the washing bags 30 temporarily stored in the container 270. However, if the searching is unsuccessful, the robovator 200 will repeat step 538 until the position of the entrance can be identified.

Once the robotic arm 210 is moved into the mesh bag collection container 270, the searching of the washing bag 30 by reinforcement learning within the container to space environment and the inner space environment begin simultaneously. The RGB-D camera 240 may capture a plurality of images and the reinforcement learning (RL) modules 230 may search the washing bags 30 from the captured images to learn the position of the washing bags 30 (step 542). If the searching is successful and the orientation of a target washing bag 30 is known, the reinforcement learning (RL) modules 230 will calculate the three-dimensional position and pose of the end-effector 212 and the compliant end-effector 212 will move to grip the targeted washing bag 30 from the mesh bag collection container 270 (step 544). However, if the searching is unsuccessful, the robotic arm 210 will move the washing bags 30 within the container 270 slightly and the robovator 200 will repeat step 542 until a washing bag 30 can be found.

As the washing bag 30 is gripped by the compliant end-effector 212, the learning of the placing area environment by reinforcement learning (RL) modules 230 begin. The robotic arm 210 may navigate through a navigation path and place the washing bag 30 to the drying machine 50 (step 546). The pick and place of the rest of the washing bags from the mesh bag collection container 270 to the drying machine 50 will be done by repeating steps 538 to 546 (step 550). Once the last washing bag 30 has been picked from the container 270 and placed into the drying machine 50, method 500b is complete and the learning assisted method 500 ends there (step 552).

Advantageously, the present invention relates to an End-to-end upcycling system with high degree of automation and integration as Industry 4.0 pioneer in the textile recycling industry which may support re-industrialization and environmental sustainability policies in Hong Kong and elsewhere. For instance, the automation of the transfer may be expanded to an automated, end-to-end PET-cotton blend material separation, decoloring and recycled yarn production system to handle textile waste regionally. Such an integrated, blended textile upcycling system can be regarded as the technology solution and at the same time a tangible showcase to the market. It will enable the technology to be more industrially recognized and easily adopted. This provides a tangible demonstration of technologies to motivate industry stakeholders to adopt and scale technologies.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, standalone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A learning assisted robotic system for transferring one or more target objects, comprising:
a robotic module arranged to transfer a target object from a starting position to a destination, at least one of the starting position and the destination being a three-dimensional environment at least partially enclosed and having an entrance through which being accessible by the robotic module; and
a learning module arranged to learn the three-dimensional positions of the entrance and the target object based on one or more training data sets;
wherein the learning module is further arranged to derive a navigational path based on the learnt three-dimensional positions whereby the robotic module is operable to navigate through the derived navigational path to transfer the target object from the starting position to the destination.

2. A learning assisted robotic system in accordance with claim 1, further comprising a sensing unit arranged to capture the data associated with the position and orientation of the object proximate to the robotic module and the training data set includes the captured data by the sensing unit.

3. A learning assisted robotic system in accordance with claim 2, wherein the robotic module is arranged to navigate to an intermediate position from an initial position and the sensing unit is arranged to capture the data associated with the position and orientation of the object proximate to the robotic module whereby the learning module is arranged to derive the further movement of the robotic module forming part of the navigational path based on the captured data by the sensing unit at the initial position and the intermediate position respectively.

4. A learning assisted robotic system in accordance with claim 1, wherein the learning module is further configured to estimate the depth of the partially enclosed three-dimensional environment beyond the entrance based on the learnt three-dimensional positions and the robotic module is arranged to navigate into the partially enclosed three-dimensional environment based on the estimated depth.

5. A learning assisted robotic system in accordance with claim 1, wherein the robotic module further includes an end-effector arranged to pick and release the target object respectively.

6. A learning assisted robotic system in accordance with claim 5, wherein the learning module is further configured to determine the maneuverable space within the partially enclosed three-dimensional environment and to determine a pick area beyond the entrance and proximate to the target object based on the learnt three-dimensional positions and the robotic module is arranged to estimate the pose for placing the end-effector and navigate the end-effector to the determined pick area.

7. A learning assisted robotic system in accordance with claim 5, wherein the learning module is further configured to estimate the pose of the target object and the robotic module is arranged to position the end-effector proximate to the target object and pick up the target object.

8. A learning assisted robotic system in accordance with claim 5, wherein the learning module is further configured to determine the maneuverable space between the entrance and a further three-dimensional environment and the robotic module is arranged to navigate the end-effector to release a picked target object to the further three-dimensional environment.

9. A learning assisted robotic system in accordance with claim 2, wherein the sensing unit further includes a depth camera unit arranged to capture one or more images associated with the three-dimensional environment, the depth camera unit being movable with respect to a base carrying the robotic module.

10. A learning assisted robotic system in accordance with claim 2, wherein the sensing unit further includes a compliant end-effector arranged to contact a target object and the data associated with the contact force of the data forms at least part of the training data set.

11. A learning assisted robotic system in accordance with claim 1, wherein the end-effector further includes a gripper module configured to pick and release the target object, the gripper module comprising a plurality of grippers with the orientation being adjustable to accommodate target object with irregular surface.

12. A learning assisted robotic system in accordance with claim 11, where the gripper includes a needle gripper.

13. A learning assisted method of transferring one or more target objects, comprising the steps of:
learning the three-dimensional positions of the entrance of an at least partially enclosed three-dimensional environment and a target object based on one or more training data sets;
deriving a navigation path for a robotic module based on the learnt three-dimensional positions; and
navigating the robotic module through the derived navigational path to transfer the target object from the starting position to the destination.

14. A learning assisted method in accordance with claim 13, further comprising the steps of:
capturing the data associated with the position and orientation of the object proximate to the robotic module;
retrieving at least part of the training data set from the captured data; and
learning the three-dimensional positions of the entrance of the partially enclosed three-dimensional environment and the target object based on one or more training data sets.

15. A learning assisted method in accordance with claim 14, further comprising the steps of:
capturing the data associated with the position and orientation of the object proximate to the robotic module at an initial position of the robotic module;
navigating the robotic module to an intermediate position from the initial position;
capturing the data associated with the position and orientation of the object proximate to the robotic module at the intermediate position of the robotic module; and
deriving a further movement of the robotic module based on the captured data at the initial position and the intermediate position respectively.

16. A learning assisted method in accordance with claim 14, further comprising the steps of:
learning the three-dimensional positions of the entrance of an at least partially enclosed initial three-dimensional environment and a target object positioned within the initial three-dimensional environment based on one or more training data sets;
deriving a first navigation path for a robotic module based on the learnt three-dimensional positions;
navigating the robotic module into the initial three-dimensional environment from an initial position through the derived first navigational path to pick the target object;
learning the three-dimensional position of a destinated three-dimensional environment based on one or more training data sets;
deriving a second navigation path for the robotic module based on the learnt three-dimensional positions; and
navigating the robotic module to the destinated three-dimensional environment through the derived second navigational path to release the picked target object.

17. A learning assisted method in accordance with claim 14, further comprising the steps of:
learning the three-dimensional positions of the entrance of an initial three-dimensional environment and a target object positioned within the first three-dimensional environment based on one or more training data sets;
deriving a first navigation path for a robotic module based on the learnt three-dimensional positions;
navigating the robotic module into the initial three-dimensional environment through the derived first navigational path to pick the target object;
learning the three-dimensional position of the entrance of an at least partially enclosed destinated three-dimensional environment based on one or more training data sets;
deriving a second navigation path for the robotic module based on the learnt three-dimensional position; and
navigating the robotic module into the destinated three-dimensional environment through the derived second navigational path to release the picked target object.

18. A gripper subassembly for transferring one or more target objects, comprising:
a base arranged to couple to an end-effector of a robotic module; and
a plurality of needle grippers arranged to intrude a portion of the surface of a soft target object in a first direction in response to an electronic signal, the needle grippers being each pivotably mounted on the base and pivotable about a pivoting axis perpendicular to the first intruding direction;
wherein the first intruding direction is adjustable by the pivotal movement of the needle gripper so as to accommodate the shape of the soft target object.

19. A gripper subassembly in accordance with claim 18, wherein the pivoting axis of two adjacent needle grippers are arranged to intersect with each other.

20. A gripper subassembly in accordance with claim 19, wherein each needle gripper includes a gear being rotatable about the pivoting axis and is connectable to another gear as bevel gears.
